(19) United States
(12) Patent Application Publication
(10) Pub. No.: US 2013/0297758 A1
(43) Pub. Date: Nov. 7, 2013

(54) METHOD AND SYSTEM FOR PROVIDING A REQUEST-ORIENTED SERVICE ARCHITECTURE

(71) Applicants: Javed Roshan, Carrollton, TX (US); Mukaram Aziz, Lewisville, TX (US); Ira Stevens, Quakertown, PA (US); Harold Wortman, Keller, TX (US)

(72) Inventors: Javed Roshan, Carrollton, TX (US); Mukaram Aziz, Lewisville, TX (US); Ira Stevens, Quakertown, PA (US); Harold Wortman, Keller, TX (US)

(73) Assignee: Verizon Patent and Licensing Inc., Basking Ridge, NJ (US)

(21) Appl. No.: 13/465,673

(22) Filed: May 7, 2012

(51) Int. Cl. G06F 15/173

(52) U.S. Cl. 709/223

(57) ABSTRACT

An approach for providing a request-oriented service architecture is described. A request from a user agent is forwarded to an originating resource manager specifying a feature and an action to be performed on the feature. A modified request is generated based on the request, the modified request including declaration information. Further, a transaction is generated based on the state of the feature and the modified request, and a current state of the feature is updated based on the transaction.

### BACKGROUND INFORMATION

Service providers are continually challenged to deliver value and convenience to consumers by providing compelling network services and advancing the underlying technologies. For example, product and service features are frequently added to network services and systems to provide consumers with additional value and convenience. When designing a system, for instance, to deploy a new product or service, developers typically create or utilize architectures that focus on actual implementations of the specifically designed product or service without, in certain instances, considering the flexibility for integrating other products or services. The development of any new product under this approach generally requires substantial time and effort and involves inflexible production systems that service many users at any one time, negatively affecting the overall cost, quality, and time-to-market for any new product or product feature.

Therefore, there is a need for a service architecture that is more flexible and effective in accommodating new services.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing a request-oriented service architecture, according to an exemplary embodiment;

FIG. 2 is a detailed diagram of a system implementing a request-oriented service architecture, according to an exemplary embodiment;

FIG. 3 is a diagram of interactions of a communication integration platform within a request-oriented service architecture, according to an exemplary embodiment;

FIG. 4 is a flowchart of a process for providing a request-oriented service architecture, according to an exemplary embodiment;

FIG. 5 is a flowchart of a process for decomposing a modified request into one or more child requests, and receiving one or more child responses, as part of a request-oriented service architecture, according to an exemplary embodiment;

FIG. 6 is a flowchart of a process for returning one or more parent responses to an originating resource manager as part of a request-oriented service architecture, according to an exemplary embodiment;

FIGS. 7A and 7B are sequence diagrams of a process for providing a request in a request-oriented service architecture, according to an exemplary embodiment;

FIG. 8 is a diagram of a computer system that can be used to implement various exemplary embodiments; and

FIG. 9 is a diagram of a chip set that can be used to implement an embodiment of the invention.

### DESCRIPTION OF THE PREFERRED EMBODIMENT

An apparatus, method and software for providing a request-oriented service architecture are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

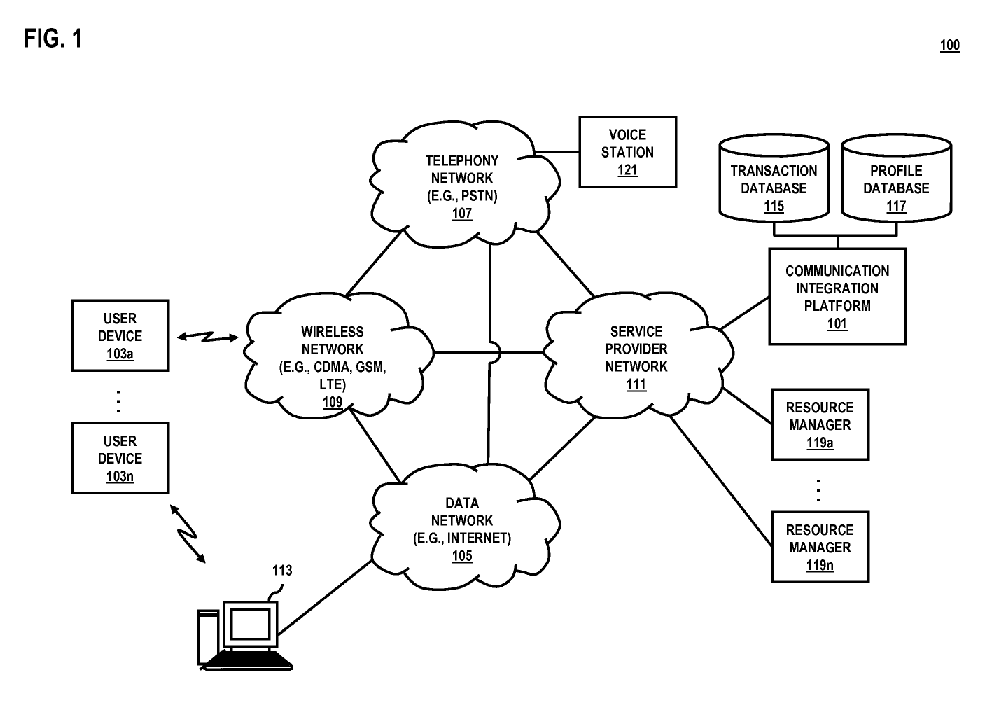

FIG. 1 is a diagram of a system capable of providing a request-oriented service architecture (ROSA), according to an exemplary embodiment. For the purpose of illustration, the system 100 employs a communication integration platform 101 that is configured to facilitate communication across disparate systems by providing a request-oriented service architecture. One or more user devices 103a-103n (collectively referred to as user devices 103) may, for instance, be utilized to initiate requests to access product and/or service features across disparate systems over one or more networks (e.g., data network 105, telephony network 107, wireless network 109, service provider network 111, etc.). In one embodiment, service and/or product features may be included as part of managed services supplied by a service provider (e.g., a wireless communication company) as a hosted or a subscription-based service made available to users of the user devices 103 through the service provider network 111. As shown, the communication integration platform 101 may be a part of, or connected to, the service provider network 111. In one embodiment, the communication integration platform 101 may be included within or connected to the user devices 103, a computing device 113, etc. While specific reference will be made thereto, it is contemplated that the system 100 may embody many forms and include multiple and/or alternative components and facilities. The communication integration platform 101, in some embodiments, can effectively reduce overall costs, decrease the time-to-market, and improve the quality for product/service features by facilitating the requests that include the concrete definitions of the product/service features based on a request-oriented service architecture.

In certain embodiments, the communication integration platform 101 may include or have access to a transaction database 115 (e.g., a long-transaction database) and a profile database 117 (e.g., a virtual enterprise state database). For example, the communication integration platform 101 may generate or update a transaction in the transaction database 115, and utilize the transactions to update product/service features in the profile database 117. In addition, in various embodiments, resource managers 119a-119n (collectively referred to as resource managers 119) may receive, for instance, a verb-noun request (e.g., initiated by a user device 103) and provide the transformation of the verb-noun request into a modified request that defines the behaviors and structures of the associated product/service features (e.g., such as those features that may be provided by a voice station 121) for a particular ROSA instance.

It is noted that the user devices 103 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 103 may support any type of interface for supporting the presentment or exchange of data. In addition, user devices 103 may facilitate various input means for receiving and generating information, including touch screen capability, keyboard and keypad data entry, voice-based input mechanisms, accelerometer (e.g., shaking the user device 103), and the like. Any known and future implementations of user devices 103 are applicable. It is noted that, in certain embodiments, the user devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 103, i.e., IP addresses that are accessible to devices connected to the service provider network 111 as facilitated via a router.

As mentioned, products and product features are frequently added to network services and systems to provide consumers with additional value and convenience. New product developments typically involve disparate system integration, which generally requires a system to provide means of maintaining a transaction extending beyond a particular system domain (e.g., a long transaction), transformations between the disparate systems, a common protocol and workflow/service system framework, and a clear, concrete implementation for the actions (and their derived actions) that define the behavior of the product being developed. Developers designing a system for a new product will create or utilize architectures (e.g., service-oriented architectures) emphasizing that a server includes the concrete implementation of the product (to varying degrees) and, thus, the definition of the product's features. However, the development of any new product under this approach generally requires substantial time and effort and involves production systems that service many users at any one time, affecting the overall cost, quality, and time-to-market for any new product or product feature.

To address these issues, the system 100 of FIG. 1 introduces the capability to provide a request-oriented service architecture. With such an architecture, any new product or product feature may be pushed away from the network (e.g., server) and into the request. In one scenario, a typical verb-noun request may be initiated by a user device 103a for access to a particular product or service feature. The verb-noun request may then be received by a resource manager 119a (e.g., an event package) that provides the transformation of the verb-noun request, for instance, into a modified form that includes the declarations (or definitions) for the particular product or service feature. The modified request may thereafter be transmitted from the resource manager 119a to a communication integration platform 101, which may then merge the contents of the request with the current state of the feature to generate (or update) a transaction in a long-transaction database (e.g., the transaction database 115) for updating the current state of the feature (e.g., in the profile database 117). The transaction may, for instance, specify the feature, the action to be performed on the feature, the current state of the feature, the declaration information, and a current status of the transaction. Additionally, or alternatively, the transaction may specify an intended state of the feature. In particular embodiments, the request may include the minimal information necessary to create, or update, the transaction. On the other hand, the transaction may be based on the request, the current state of the feature, and other requests, for instance, to provide the explicit action and status. It is noted that, in some embodiments, the transformed request (and resulting child request, discussed below) may, for instance, be the only means of defining the structure and behavior of a product or service feature. The communication integration platform 101 may be deployed within one or more servers, and act as a broker or a facilitator of the request rather than define or maintain the new product or product feature. As such, the servers may only be required to provide very abstract services for maintaining long-transactions, providing domain integrations points, and defining the request meta-model.

In certain embodiments, the communication integration platform 101 may decompose a modified request (e.g., a parent request) into one or more child requests based on the declaration information. The communication integration platform 101 may further route the one or more child requests to one or more resource managers 119 (e.g., a destination or compensating resource managers) based on the declaration information. By way of example, the declaration information may include behavior declarations and/or structure declarations for product/service features. Since the behaviors and the structures for a product/service feature are declared in the request, they may, for instance, be utilized by the communication integration platform 101 as a set of “instructions” for breaking down the request into corresponding child requests and for routing the child requests to the various resource managers 119 to carry out respective parts of the request. It is noted that, in some embodiments, the communication integration platform 101 may also act as a resource manager (e.g., a destination or compensating resource manager). For example, a child request may be destined for the communication integration platform 101 to be further decomposed into one or more grandchild requests based on the declaration information.

By way of example, in one embodiment, the request may include an action to setup a conference using a conferencing feature provided by a conferencing service. Based on the declaration information, the resulting modified request, which was generated from the initial request to include the declaration information, may be decomposed into several child requests including: (1) a child request that includes the necessary behavior and structure declarations for a provisioning feature for routing to a provisioning adapter that will transform the child request into instructions to provision network resources (e.g., bandwidth) for the conference; (2) a child request that includes the necessary behavior and structure declarations for the directory feature for routing to a directory adapter that will transform the child request into instructions to provide contact information of invitees for the conference; and (3) a child request that includes the necessary behavior and structure declarations for the conference feature for routing to a conference adapter that will transform the child request into instructions to utilize the provisioned network resources and the contact information to setup the conference.

Subsequently, in various embodiments, the communication integration platform 101 may receive one or more child responses in response to the routing of the one or more child requests. The communication integration platform 101 may further generate a parent response based on the declaration information and the one or more child responses for transmission to the originating resource manager, and ultimately to the originating user device 103a. By way of example, the provisioning adapter, the directory adapter, and the conference adapter may respectively transmit child responses with the state “completed” upon learning that the network resources have been provisioned, that the contact information has been provided, and that the conference has been setup based on the provisioned network sources and the contact information. As such, the communication integration platform 101 will generate a parent response based on the declaration information to inform the originating resource manager that the conference has been setup.

In other embodiments, the communication integration platform 101 may transmit the one or more child responses to the transaction database 115 to trigger an update for the transaction in the transaction database 115, wherein the current state of the feature is updated in the profile database 117 based on the updated transaction. In one scenario, when the child responses are respectively received from the provisioning adapter, the directory adapter, and the conference adapter with the state “completed,” the communication integration platform 101 may, for instance, update the associated transaction in the transaction database 115. This may, in turn, cause an update to the current state of the feature (or features) in the profile database 117.

Furthermore, the communication integration platform 101, the user devices 103, the computing device 113, the resource managers 119, the voice station 121, and other elements of the system 100 may be configured to communicate via the service provider network 111. According to certain embodiments, one or more networks, such as the data network 105, the telephony network 107, and/or the wireless network 109, may interact with the service provider network 111. The networks 105-111 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-111 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-111 may include components and facilities to provide for signaling and/or bearer communications between the various components or facilities of the system 100. In this manner, the networks 105-111 may embody or include portions of a signaling system 7 (SS7) network, Internet protocol multimedia subsystem (IMS), or other suitable infrastructure to support control and signaling functions.

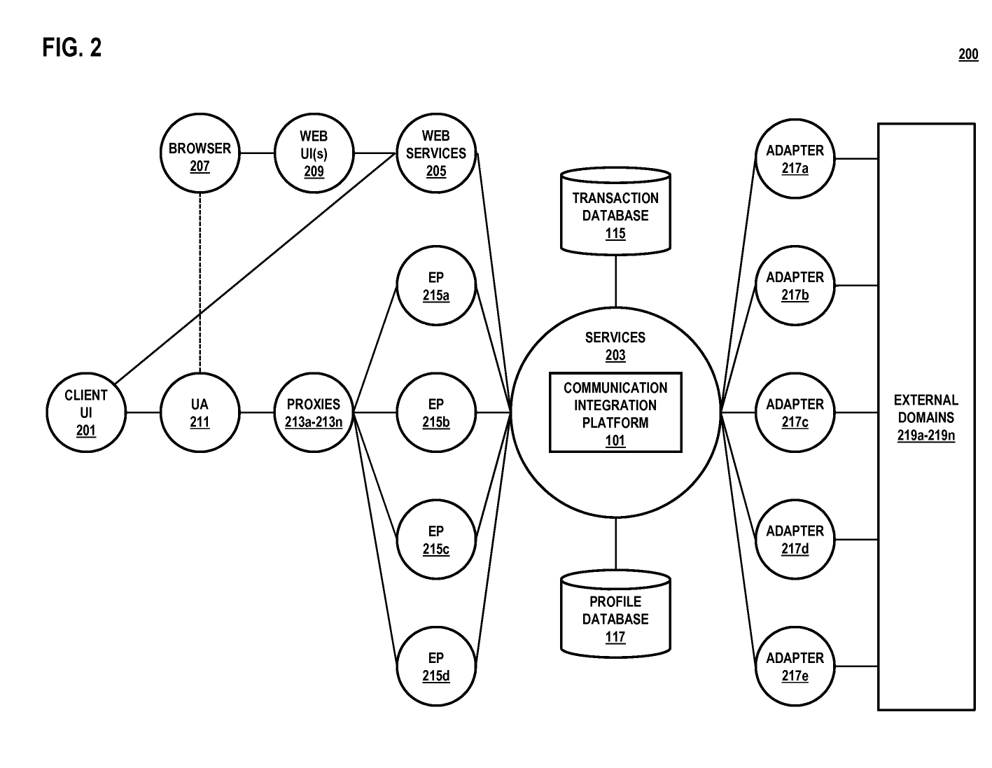

FIG. 2 is a detailed diagram of a system implementing a request-oriented service architecture, according to an exemplary embodiment. By way of example, an end-user may utilize a device (e.g., user device 103) with a client user interface 201 to access services 203 provided through web services 205. The client user interface 201 may, for instance, utilize a browser 207 and a web user interface 209 (e.g., via a user agent 211) to initiate requests (e.g., verb-noun requests) through the web service 205. Additionally, or alternatively, the client user interface 201 may access services 203 through the user agent 211 and proxy servers 213a-213n (collectively referred to as proxy servers 213) (e.g., proxies 213a-213n in FIG. 2).

In one scenario, an application associated with a client user interface 201 may send a traditional verb-noun request pattern to instigate a system-task. The verb-noun request may be generated at a client user interface 201 and transmitted from the user agent 211 associated with the client user interface 201 to one or more of the proxy servers 213. The verb-noun request may use a session control protocol, such as session initiation protocol (SIP), to initiate a communication with one or more of the proxy servers 213. In one embodiment, the system 200 may provide load balancing between the various proxy servers 213 for many SIP requests. The proxy servers 213 may then initiate a SIP request to one or more event packages 215a-215d (collectively referred to as event packages 215) (e.g., EP 215 in FIG. 2). The event packages 215 selected may be based on the particular feature set and/or action associated with the request, such a presence event package for a presence feature set. Based on the SIP requests directed to the various event packages, the requests may be implemented in a published and subscribed based architectural pattern (“pub/sub model”). Accordingly, the user agent 211, proxy servers 213 and event packages 215 may form a SIP-centric protocol over transport layer security, splitting feature groups associated with the requests into relocatable SIP-event packages, such as telephony services, directory services and rich presence. Such an architecture provides peer-to-peer and unsolicited event delivery.

When a verb-noun request is received from the client user interface 201 at one of the event packages 215 (e.g., acting as an originating resource manager 119), the verb-noun request may be transformed into a modified request that specifies the service feature, actions to be performed with respect to the service feature, and behavior and/or structure declarations associated with the service feature (as well behavior and/or structure declarations associated with a corresponding transaction). The modified request may then be transmitted from the event packages 215 to the communication integration platform 101. The communication integration platform 101 may then merge contents of the modified request with a current state of the feature to generate (or update) a transaction (e.g., a long-transaction). As indicated, the transaction may be stored in the transaction database 115.

Then, the modified (or parent) request may be decomposed into one or more child requests based on the declaration information contained in the request (e.g., behavior and/or structure declarations) and thereafter be routed to one or more adapters 217a-217e (collectively referred to as adapters 217) (e.g., acting as destination resource managers 119) based on the behavior and/or structure declarations. The adapters 217 may then process the child requests for their respective external domains 219a-219n (collectively referred to as external domains 219) by converting the child requests into “instructions” for components of the external domains 219 that will implement various parts of the request. Upon notification by the components to the adapters 217 that the various parts of the request have been completed, the adapters 217 may each transmit one or more child responses with the state “completed” to the communication integration platform 101. As discussed, the communication integration platform 101 may collect and analyze all of the child responses and generate a collective response (e.g., parent response) based on the behavior and/or structure declarations of the modified (parent) request for transmission to the event packages 215 from which the modified (parent) request originated. In addition, the communication integration platform 101 may transmit the child responses to the transaction database 115 to cause an update for the associated transaction. As a result, the current state of the feature may also be updated in the profile database based on the updated transaction.

It is noted that, although various embodiments are described with respect to requests flowing from external users to external domains, it is contemplated that the reverse may also be true. Thus, the approach described herein may similarly apply to requests flowing from external domains to external users (e.g., call status updates).

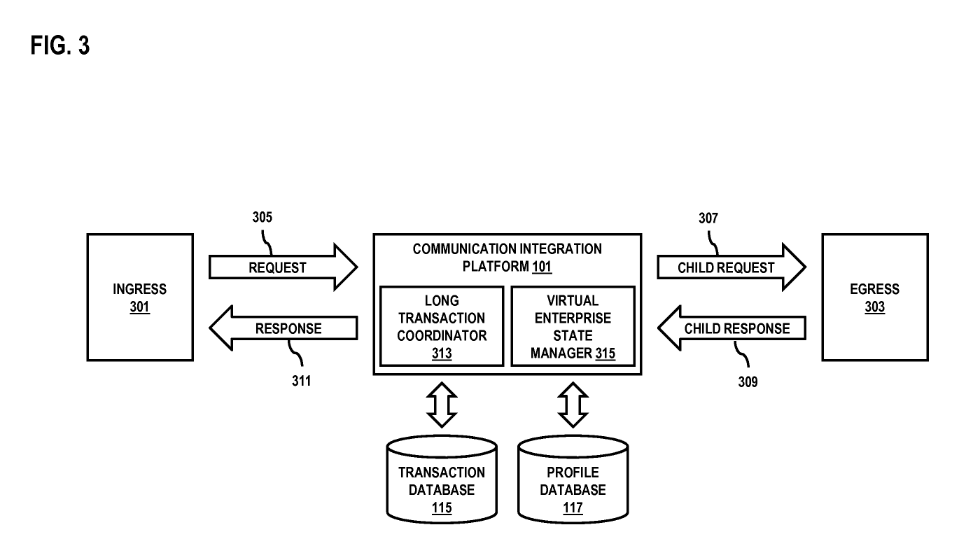

FIG. 3 is a diagram of interactions of the communication integration platform 101, according to an exemplary embodiment. As shown, in some embodiments, a request-oriented service architecture (ROSA) may be implemented based on a hub-and-spoke architecture model. In such a model, the communication integration platform 101 may, for instance, act as a facilitator (or the “hub”) for various external domains (e.g., the external domains 219 of FIG. 2) while one or more resource managers 119 (e.g., the event packages 215 and adapters 217 of FIG. 2) (or the “spokes”) provide the ingress and egress transforms (e.g., ingress 301 and egress 303) to the various external domains. Communications between the communication integration platform 101 and the resource managers 119 (or other spoke endpoints) may, for instance, be performed by a request/response protocol over a guaranteed delivery transport. As indicated, the long-transaction coordinator 313 and the virtual enterprise state manager 315 may work together to provide the current state of any request 305, child request 307, child response 309, or response 311 within a particular instance, or trusted group of instances, of a request-oriented service architecture. It is noted that, in certain embodiments, the request-oriented service architecture may incorporate features from multiple systems and lines-of-business, and present them as one in a generic fashion (e.g., understood by the particular instance, the trusted group of instances, etc.).

In one embodiment, a request-oriented service architecture moves the declaration (or definition) information (e.g., structural declarations, behavior declarations, etc., associated with a transaction, a feature, etc.) away from a concrete system specification (e.g., web-services, UNIX-like daemons, window services, rule-engines or work-flow systems, etc.) to the request itself, which enables the request to “know” how to act within its own ROSA system or ROSA domain of systems. In other words, the requests 305 may include declaration information that can be understood by a single ROSA instance or common/trusted ROSA instances/groups that share behavioral and structural definitions. However, an external (or untrusted) system may not understand, for instance, the definitions for the behaviors of another system.

Once received at the ingress 301, a transform to the modified form of the request may occur, forming, for instance, the request 305. This modified form may contain both structure and behavior declarations, derived from the original verb-noun request. Thus, from the ingress point, the request 305 may be self-sufficient. That is, the request 305 may have its own life-cycle and the ability to traverse its environment in order to accomplish the task for which the request 305 was intended. In some embodiments, the request 305 may include the current state of the system and the concept library (and/or aspect dictionary) for the particular ROSA instance. As used herein, an “aspect” may define a programmable behavioral or structural concern, and a “concept” may refer to a language neutral operation or type that is utilized by various “aspect” definitions.

In a further scenario, the communication integration platform 101 may receive the request 305 from an originating resource manager (e.g., an event package configured to act as a compensating resource manager 119 at the ingress 301) and then merge the request 305 with a current state of the virtual enterprise to create, or modify, a long-transaction (e.g., a transaction that extends beyond the system domain, but not necessarily “long” in terms of time) that is stored, or updated, in the transaction database 115. As such, an update to the relevant portions of the profile database 117 may then be automatically initiated. In certain embodiments, the profile database 117 is not updated directly. Instead, the profile database 117 is updated by a transaction that is created, or modified, by requests (e.g., requests/responses 305, 307, 309, and 311).

Then, the communication integration platform 101 may decompose the request 305 into child request(s) 307 (e.g., based on the behavior declarations in the request 305) and subsequently route the child request(s) 307 to the respective destinations (e.g., based on the behavior declarations). It is noted that spokes of a hub-and-spoke architecture may include the destination components, which may, for instance, be compensating resource managers (e.g., adapters 217 of product/service features). It is also noted that, in some cases, the destination for the child requests 307 may be within the communication integration platform 101 (e.g., if the communication integration platform 101 is acting as the associated compensating resource manager), allowing for those child requests 307 to be further decomposed into grandchild requests and so on for routing to their respective destinations.

In response to the routing of child request(s) 307, the communication integration platform 101 may receive child response(s) 309 from the destination components. The long-transaction coordinator 313 may then trigger an update to the associated transaction in the transaction database 115, which, in turn, may cause an update to the current state of the virtual enterprise. Based on the behavior declarations of the request 305 (e.g., the parent (modified) request of the child request(s) 307), a response 311 may, for instance, be generated and sent to the originator of the request 305 (e.g., the event package configured to act as a compensating resource manager 119) once all of the child response(s) 309 are collected and analyzed. In various embodiments, the response 311 may, for instance, relate to the updated state of the virtual enterprise state.

In various embodiments, the difference between a request 305 and a transaction is that the request 305 may only include the minimal information necessary to create, or update, the transaction, but the transaction itself would use the current enterprise state and other requests 305 to provide the explicit action and status. Nonetheless, the schemas for a request 305 and a transaction may be identical even where their respective contents are different. In some embodiments, the schemas for the various requests and responses may also be the same even if, for instance, their respective actions may be different. As such, there may be no need for an explicit “request” or “response” type, since they may both just be variations of the “transaction” type.

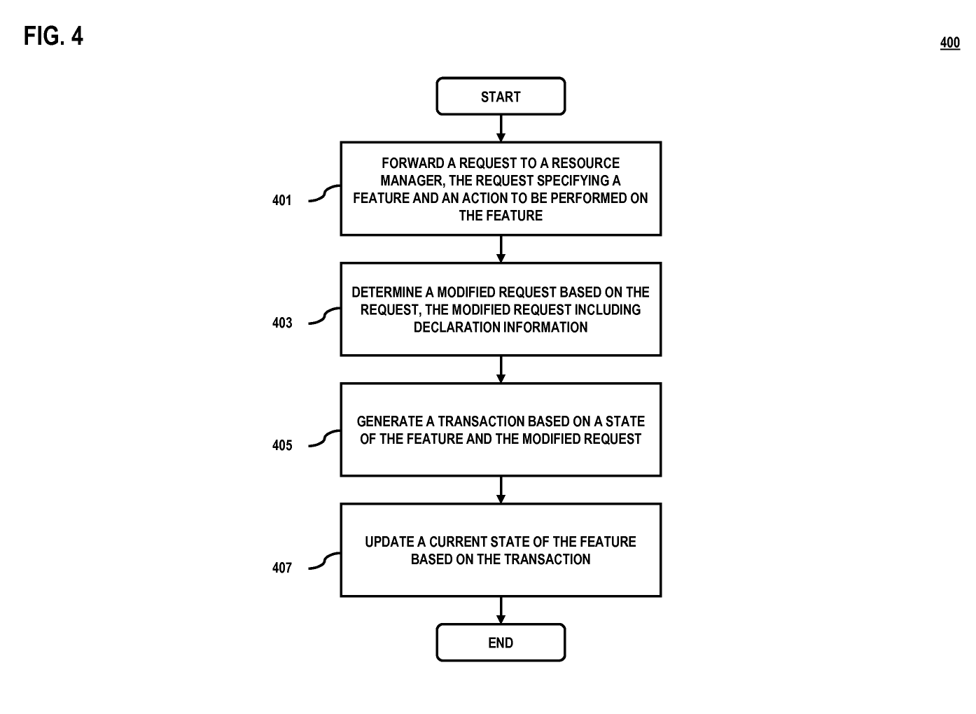

FIG. 4 is a flowchart of a process for providing a request-oriented service architecture, according to an exemplary embodiment. For the purpose of illustration, process 400 is described with respect to FIG. 2. It is noted that the steps of the process 400 may be performed in any suitable order, as well as combined or separated in any suitable manner. In step 401, a request is generated and received at a resource manager, such as one of the event packages 215 illustrated in FIG. 2. In one embodiment, the request may be received and forwarded to the web services 205 of FIG. 2, which may also act as a resource manager. In one embodiment, the request may be a typical verb-noun request specifying a feature and an action to be performed on the feature. The feature may be associated with a service, a product, or a combination thereof, and the feature (or an instance of the feature) may be stored in the profile database 117. By way of example, the request may specify a required bandwidth associated with a conferencing call request. In one embodiment, as discussed above, the request may first be received from the user agent 211 at one of a plurality of proxy servers 213 illustrated in FIG. 2. The request may be in the form of a SIP protocol request and may be sent to a SIP proxy farm. Then, the proxy server 213a that received the request may transfer the request to one of the event packages 215a.

At step 403, the resource manager 119 (e.g., the event package 215a) may then generate a modified request based on the received request. The generated modified request will include declaration information that may include a behavior declaration, a structure declaration, or a combination thereof. By way of example, in one embodiment, an event package 215a will receive the request and subsequently analyze the request to determine the feature associated with the request and the action associated with the feature. Based on the feature and/or the action, the event package 215a will determine the appropriate declaration information to generate a modified request that is self-sustaining within the request-oriented service architecture. By way of example, where the request is associated with provisioning the bandwidth for a conferencing call request, the event package 215a will determine the declaration information based on the conferencing call and bandwidth features.

In step 405, the modified request may be sent to the communication integration platform 101, and the communication integration platform 101 may merge contents of the request with a current state of the feature to generate a transaction, wherein the transaction is used to update the current state of the feature. In some embodiments, the transaction may be a long-transaction stored in the transaction database 115. The transaction may, for instance, specify the feature, the action to be performed on the feature, the current state of the feature, the declaration information, and a current status of the transaction. Additionally, or alternatively, the transaction may specify an intended state of the feature. As mentioned, in particular embodiments, the request may include the minimal information necessary to create, or update, the transaction. On the other hand, the transaction may be based on the request, the current state of the feature, and one or more other requests, for instance, to provide the explicit action and status.

It is noted that, in certain embodiments, the communication integration platform 101 may convert a request from an originator into an expanded transaction, provide transaction state coordination between the transaction database 115 and the profile database 117, instigate transaction decomposition, and instigate responses back to the originator.

For illustrative purposes, specific details are provided with respect to various embodiments. By way of example, a transaction may be the combination of two entities: the profile and the request. The request may simply indicate the request and request-feature level change expectations, and the profile may provide the profile-feature level state. When a request is merged with the profile, both the current state and requested state may be combined to form the transaction. Example code may, for instance, include:

<!-- Current Profile: -->

<Profile>

<Identifier>{301056C6}</Identifier>
<ProfileFeatures>
<ProfileFeature>
<Identifier>{C7ADEE82}</Identifier>

<Body>

<Contact
FirstName=“Bill”
LastName=“Waters”/>

</Body>

</ProfileFeature>
<ProfileFeature>

<Identifier>{E7FC9EFB}</Identifier>

<Body>

<HomeAddress
City=“Quogue”
Street=“222 South Oak Street”
State=“NY”
ZipCode=“99288”/>

</Body>

</ProfileFeature>

</ProfileFeatures>

</Profile>

<!-- Change Address Request: -->
<Request>

<Action>Begin</Action>
<Profile>

<Identifier>{301056C6}</Identifier>
<ProfileFeatures>

<ProfileFeature>

<Action>Update</Action>
<Identifier>{E7FC9EFB}</Identifier>
<Body>

<HomeAddress Street=“333 North Elm Street”/>

</Body>

</ProfileFeature>

</ProfileFeatures>

</Profile>

</Request>
<!-- Resulting Transaction: -->
<Transaction>

<Action>Begin</Action>
<Profile>

<Identifier>{301056C6}</Identifier>
<ProfileFeatures>

<ProfileFeature>

<Action>Query</Action>
<Identifier>{E7FC9EFB}</Identifier>
<Body>

<HomeAddress
City=“Quogue”
Street=“222 South Oak Street”
State=“NY”
ZipCode=“99288”/>

</Body>

</ProfileFeature>
<ProfileFeature>

<Action>Update</Action>
<Identifier>{E7FC9EFB}</Identifier>
<Body>

<HomeAddress
City=“Quogue”
Street=“333 North Elm Street”
State=“NY”
ZipCode=“99288”/>
<HomeAddress Street=“333 North Elm Street”/>

</Body>

</ProfileFeature>

</ProfileFeatures>

</Profile>

</Request>

Before the merge happens, it may be required that Identifiers (e.g., <Identifier>) be determined from Identities. Identifiers may, for instance, be the database primary key for a particular profile or profile feature, whereas Identities may be unique fields within a request that can be used to determine the primary key of a particular profile or profile-feature. For example, a profile may have a profile-feature called a “customer subscriber number” that could be used in a request in place of the profile Identifier. The pre-merge-task would know (e.g., coded into the request, based on a meta-model, etc.) that the Identity “customer subscriber number” is used to determine the Identifier for that customer profile. In this way, and in this example, the profile could contain many customers identified by a multitude of ways for the sake of a multitude of upstream or downstream systems.

Next, in step 407, the communication integration platform 101 may update the current state of the feature associated with the modified request based on the generated transaction. In some embodiments, the communication integration platform 101 may coordinate changes to the profile database 117 using the transaction database 115. That is, the profile database 117 may not updated directly. Instead, the profile database 117 may be updated by creating and executing a transaction. This task may also depend on the action that the transaction is requesting (e.g., Begin/Create, Submit, Complete/End, etc.). In one embodiment, a well-known optimistic locking mechanism may be used to synchronize changes to a single feature of any particular profile. A failure case may, for instance, only require re-merging of the feature. However, in cases where merging isn't be possible, a rollback may result.

In various embodiments, as discussed below, the communication integration platform 101 may instigate transaction decomposition into child requests. In addition, the communication integration platform 101 may correlate responses of child requests with a parent, update the parent transaction (and, thus, the associated profile) appropriately, and provide the final response to the origin of the parent request will include declaration information.

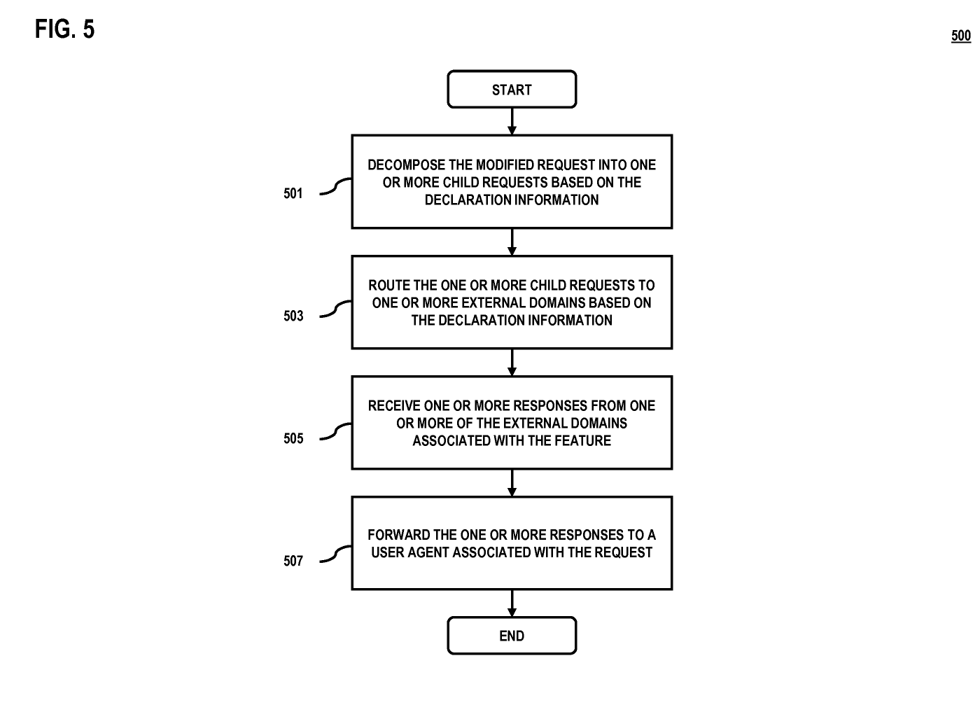

FIG. 5 is a flowchart of a process for decomposing a modified request into one or more child requests, and receiving one or more child responses, as part of a request-oriented service architecture, according to an exemplary embodiment. For the purpose of illustration, process 500 is described with respect to FIG. 2. It is noted that the steps of the process 500 may be performed in any suitable order, as well as combined or separated in any suitable manner. In step 501, the communication integration platform 101 may decompose the request into one or more child requests based on the declaration information, wherein the request is a parent request of the one or more child requests. The declaration information contained in the modified (parent) request may be used by the communication integration platform 101 to determine the various external domains 219 that are associated with the request. Based on the feature and/or action associated with the request, in combination with the desired destination external domains 219 and associated adapters 217, the communication integration platform 101 will generate various child requests accordingly. By way of example, a request may be associated with a telephony adapter 217b and a directory adapter 217c. Thus, the communication integration platform 101 will decompose the modified (parent) request into at least two child requests for the respective telephony adapter 217b and the directory adapter 217c.

The communication integration platform 101 may then, at step 503, route the one or more child requests to one or more external domains 219 based on the declaration information. As discussed, the declaration information may include behavior declarations and/or structure declarations for product/service features. Since the behaviors and the structures for a product/service feature are declared in the request, they may, for instance, be utilized by the communication integration platform 101 as a set of “instructions” for breaking down the request into corresponding child requests and for routing of the child requests to the external domains to carry out respective parts of the request. In one embodiment, the communication integration platform 101 transmits the child requests to the various adapters 217 of FIG. 2 (e.g., resource managers 119), which then forward instructions associated with the child requests to the respective external domains 219 for performing the various actions included in the original request.

In step 505, the communication integration platform 101 may receive one or more child responses from the one or more external domains 219 (and the adapters 217) in response to the routing of the one or more child requests. The communication integration platform 101 may then, at step 507, generate a parent response based on the declaration information and the one or more child responses for transmission to the user agent 211. By way of example, each of the external domains 219 may carry out the respective instructions based on the child requests. Upon completion, the external domains 219 may each transmit the state “completed” in a child response through the respective adapters 217, or the respective adapters 217 themselves will generate and transmit a child response, to the communication integration platform 101. The communication integration platform 101 may then collect and analyze all of the child responses and generate a collective parent response based on the declaration information (e.g., the behavior and/or structure declarations of the parent request) for transmission to the user agent 211.

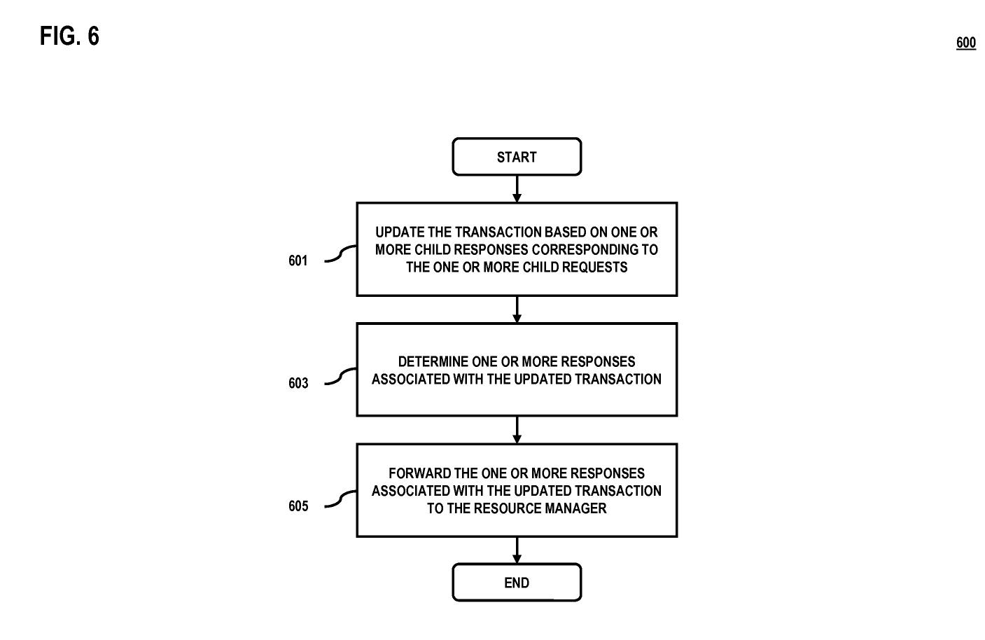

FIG. 6 is a flowchart of a process for returning one or more parent responses to an originating resource manager 119 as part of a request-oriented service architecture, according to an exemplary embodiment. For the purpose of illustration, process 600 is described with respect to FIG. 2. It is noted that the steps of the process 600 may be performed in any suitable order, as well as combined or separated in any suitable manner. In step 601, the communication integration platform 101 may transmit the one or more child responses corresponding to the one or more child requests to the transaction database 115 to trigger an update for the transaction in the transaction database 115, wherein the current state of the feature is updated in the profile database 117 based on the updated transaction.

Then, in step 603, the communication integration platform 101 may determine one or more responses associated with the updated transaction. The one or more responses may be one or more parent responses that are based on the updated transaction. For example, as discussed above, upon completion of the instructions sent by the adapters 217 to the various external domains 219, the external domains 219 may each transmit the state “completed” in a child response through the respective adapters 217 to the communication integration platform 101. The communication integration platform 101 may then collect and analyze all of the child responses and determine one or more parent responses to send to the user agent 211 based on the child responses.

At step 605, the communication integration platform 101 may then generate a collective parent response based on the declaration information of the generated modified request (e.g., based on the behavior and/or structure declarations of the parent request). The communication integration platform 101 may then transmit the collective parent response to the resource managers 119 (e.g., event packages 215) that initially forwarded the modified request (e.g., the parent request). The resource managers may then transmit the parent response to the user agent 211 such that the user agent 211 and the client user interface 201 may be updated with the current state of the feature.

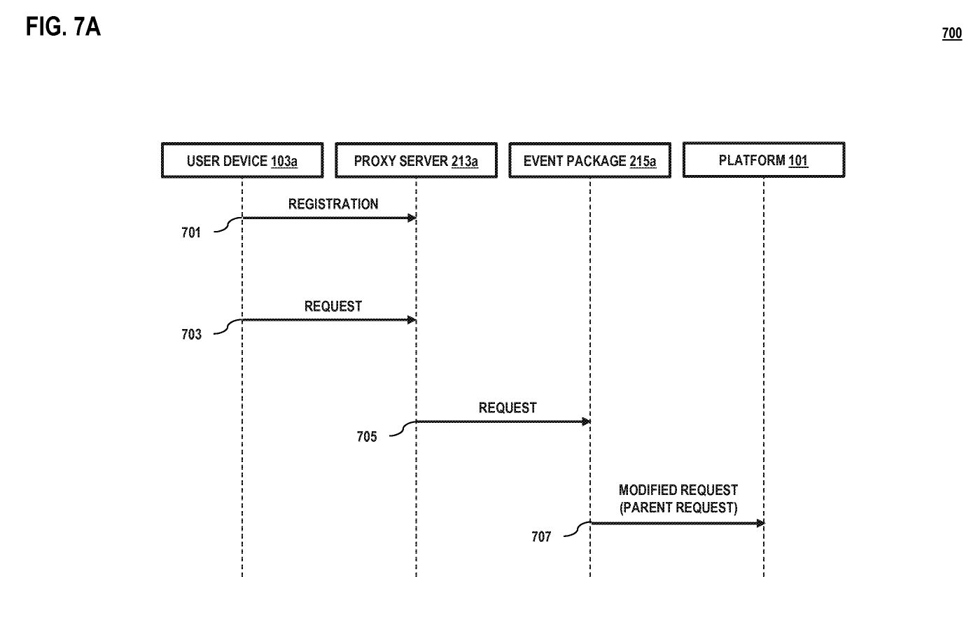

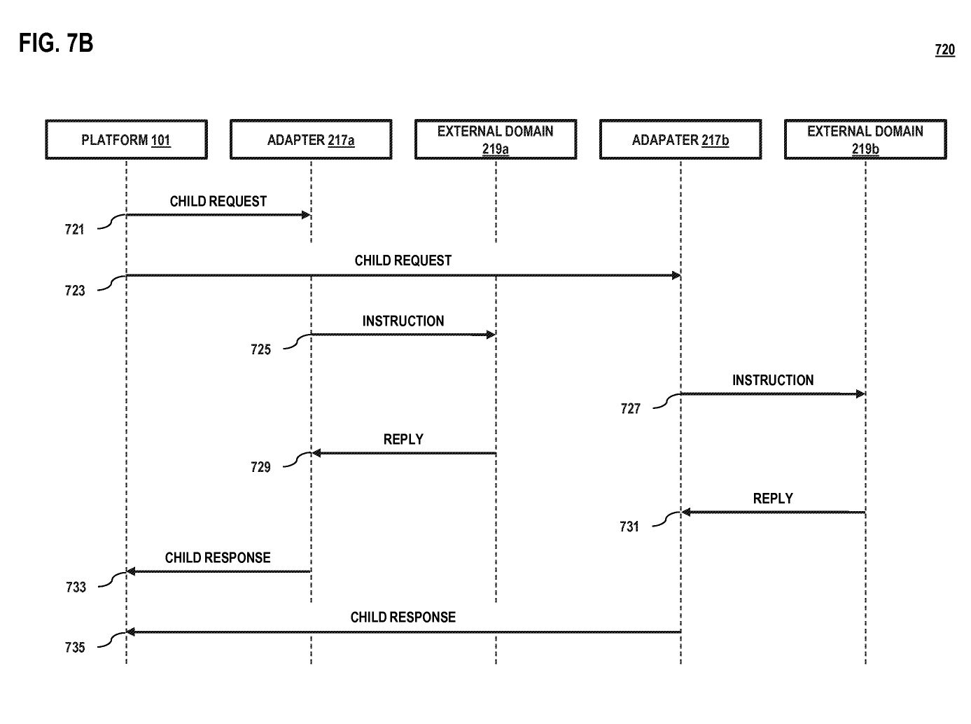

FIGS. 7A and 7B are sequence diagrams of a process for providing a request in a request-oriented service architecture, according to an exemplary embodiment. With respect to FIG. 7A, the exemplary embodiment includes a user device 103a, a proxy server 213a, an event package 215a and the communication integration platform 101. In an exemplary embodiment, the user device 103a may register in step 701 with a proxy server 213a. For example, a user agent 211 associated with the user device 103a may send a registration request to a particular proxy server 213a. In one embodiment, the request may be indirectly sent from the user device 103a to the proxy server 213a through a load balancer that redirects a registration request from a user device 103a to a particular proxy server 213a. Accordingly, the proxy server 213a registers the user agent 211 of the user device 103a. In one embodiment, the proxy server 213a may have previously registered with one or more event packages 215, or may subsequently register with an event package 215a.

Subsequently, the user device 103a may send a request to the proxy server 213a associated with a feature and an action to be performed on the feature at step 703. The feature may be associated with one or more adapters 217 and external domains 219. By way of example, the action may be the provisioning of bandwidth associated with the feature of video conferencing. Thus, the feature may be associated with an adapter 217a for video conferencing and the external domain 219a of the service that provides the video conferencing. Based on the feature and/or the action to be performed on the feature, in step 705 the proxy server 213a may then forward the request to the particular event package 215a that is associated with the feature and/or the action to be performed on the feature, such as a video conferencing event package 215a. Once received at the event package 215a, the event package 215a may modify the request to include declaration information. As discussed above, such declaration information may include declarations (or definitions) for the particular product or service feature such that the request is self-sustaining within the request-oriented service architecture. The modified request (e.g., parent request) may thereafter be transmitted from the event package 215a to the communication integration platform 101 at step 707.

After the modified request is transferred to the communication integration platform 101, the communication integration platform 101 may merge the contents of the request with the current state of the feature to generate (or update) a transaction in the transaction database 115 for updating the current state of the feature (e.g., in the profile database 117). The transaction may, for instance, specify the feature, the action to be performed on the feature, the current state of the feature, the declaration information, and a current status of the transaction. Additionally, or alternatively, the transaction may specify an intended state of the feature. Further, the communication integration platform 101 may decompose the modified request (e.g., parent request) into one or more child requests based on the declaration information.

As illustrated in FIG. 7B, the communication integration platform 101 may further route one or more child requests to one or more adapters 217 (e.g., destination resource managers 119) based on the declaration information. By way of example, the declaration information may include behavior declarations and/or structure declarations for product/service features. Since the behaviors and the structures for a product/service feature are declared in the request, they may, for instance, be utilized by the communication integration platform 101 as a set of “instructions” for breaking down the request into corresponding child requests and for routing of the child requests to the various adapters 217 (e.g., resource managers 119) to carry out respective parts of the request. By way of example, the modified request of FIG. 7A may be broken down into two child requests that are separately forwarded to corresponding adapters 217a and 217b in steps 721 and 723, respectively. More specifically, the modified request may include an action to setup a conference using a conferencing feature provided by a conferencing service. Based on the declaration information, the modified request may be decomposed into the two child requests including: (1) behavior and structure declarations for a provisioning feature for routing to a provisioning adapter 217a at step 721, and (2) a child request that includes the necessary behavior and structure declarations for a directory feature for routing to a directory adapter 217b at step 723. Subsequently, at step 725, the provisioning adapter 217a may transform the child request into instructions to transmit to, for example, an external domain 219a to provision network resources (e.g., bandwidth) for the conference. Additionally, at step 727, the directory adapter 217b will transform the child request into instructions to transmit to, for example, an external domain 219b to provide contact information of invitees for the conference.

In one embodiment, after the adapters 217a and 217b transmit the instructions to the external domains 219a and 219b, respectively, the adapters 217a and 217b may wait for replies from the external domains 219a and 219b indicating that the instructions were performed and/or returning information associated with the instructions (e.g., contact information of invitees of the conference with respect to the external domain 219b). Accordingly, the external domain 219a may forward a reply in step 729 back to the adapter 217a indicating that the feature was provisioned according to the instructions. Further, the external domain 219b may forward a reply in step 731 back to the adapter 217b providing the contact information of the invitees for the conference. Upon the adapters 217a and 217b receiving the replies, the adapters 217a and 217b may generate child responses with, for example, the state “completed” and/or any information that was requested from the external domains 219a and 219b and send the child responses back to the communication integration platform 101 at steps 733 and 735. The communication integration platform 101 may then generate a parent response based on the declaration information to inform the originating user device 103a illustrated in FIG. 7A that, for example, the conference has been setup. In one embodiment, the communication integration platform 101 may also transmit the one or more child responses to the transaction database 115 to trigger an update for the transaction in the transaction database 115, wherein the current state of the feature is updated in the profile database 117 based on the updated transaction. The parent response may be routed back to the originating user device 103a according to the route illustrated in FIG. 7A through the event package 215a and the proxy server 213a that routed the original parent response (e.g., modified response) to the communication integration platform 101.

The processes described herein for providing a request-oriented service architecture may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

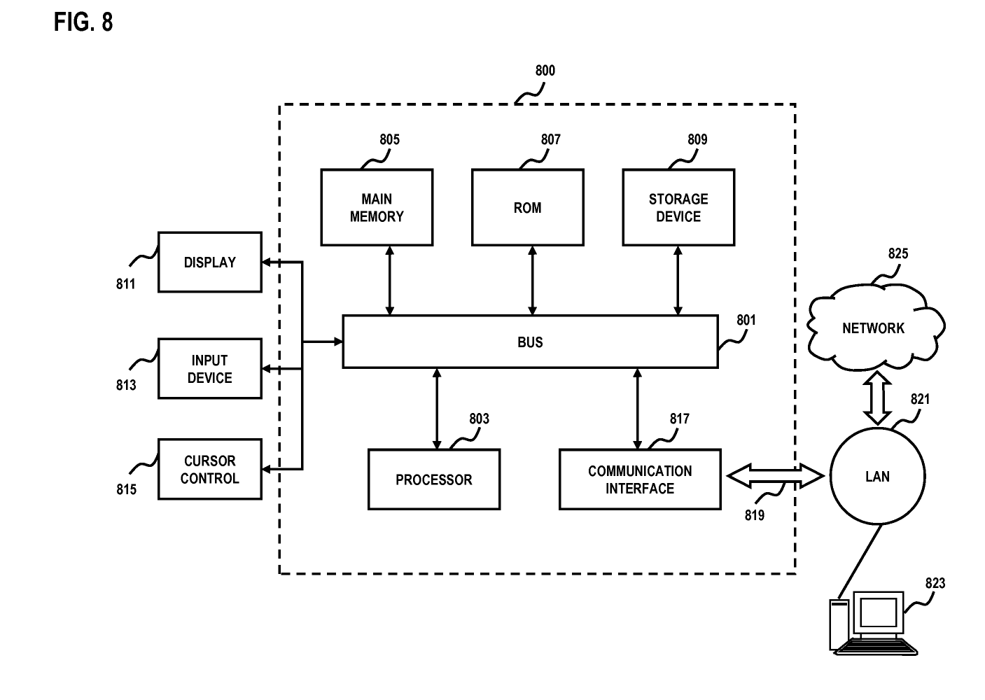

FIG. 8 is a diagram of a computer system that can be used to implement various exemplary embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk, flash storage, or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. Additional output mechanisms may include haptics, audio, video, etc. An input device 813, such as a keyboard including alphanumeric and other keys, is coupled to the bus 801 for communicating information and command selections to the processor 803. Another type of user input device is a cursor control 815, such as a mouse, a trackball, touch screen, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

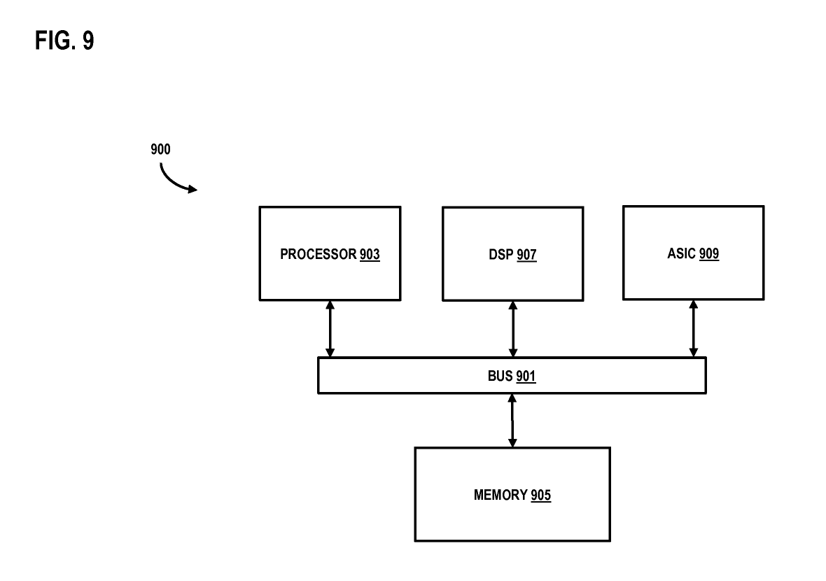

FIG. 9 illustrates a chip set or chip 900 upon which an embodiment of the invention may be implemented. Chip set 900 is programmed to enable a request-oriented service architecture as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling a request-oriented service architecture.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to enable a request-oriented service architecture. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
forwarding a request to a resource manager, the request specifying a feature and an action to be performed on the feature;
generating a modified request based on the request, the modified request including declaration information;
generating a transaction based on a state of the feature and the modified request; and
updating a current state of the feature based on the transaction.

2. A method of claim 1, wherein the feature is associated with a product, a service, or a combination thereof of a system, and the declaration information includes a behavior declaration, a structure declaration, or a combination thereof for interpreting the request.

3. A method of claim 2, further comprising:
receiving one or more responses from an external domain associated with the feature based on the declaration information; and
forwarding the one or more responses to a user agent associated with the request.

4. A method of claim 3, wherein the request is received from a user agent associated with an application executed by a user device, and the external domain is associated with at least one of telephony services, calendar services, directory services, and conference services.

5. A method of claim 1, wherein the transaction includes the declaration information, the feature, an action to be performed on the feature, the current state of the feature, and a status of the transaction, or a combination thereof.

6. A method of claim 1, further comprising:
decomposing the modified request into one or more child requests based on the declaration information; and
routing the one or more child requests to one or more external domains based on the declaration information.

7. A method of claim 6, further comprising:
updating the transaction based on one or more child responses corresponding to the one or more child requests;
determining one or more responses associated with the updated transaction; and
forwarding the one or more responses associated with the updated transaction to the resource manager.

8. A method of claim 1, further comprising:
receiving the request at one or more proxy servers, the one or more proxy servers hosting the one or more event packages.

9. An apparatus comprising:
at least one processor; and
at least one memory including computer program code for one or more programs,
the at least one memory and the computer program code configured to, with the at least one processor, cause the apparatus to perform at least the following,
forward a request to a resource manager, the request specifying a feature and an action to be performed on the feature;
generate a modified request based on the request, the modified request including declaration information;
generate a transaction based on a state of the feature and the modified request; and
update a current state of the feature based on the transaction.

10. An apparatus according to claim 9, wherein the feature is associated with a product, a service, or a combination thereof of a system, and the declaration information includes a behavior declaration, a structure declaration, or a combination thereof for interpreting the request.

11. An apparatus according to claim 9, wherein the apparatus is further caused to:
receive one or more responses from an external domain associated with the feature based on the declaration information; and
forward the one or more responses to a user agent associated with the request.

12. An apparatus according to claim 11, wherein the request is received from a user agent associated with an application executed by a user device, and the external domain is associated with at least one of telephony services, calendar services, directory services, and conference services.

13. An apparatus according to claim 9, wherein the transaction includes the declaration information, the feature, an action to be performed on the feature, the current state of the feature, and a status of the transaction, or a combination thereof.

14. An apparatus according to claim 9, wherein the apparatus is further caused to:
decompose the modified request into one or more child requests based on the declaration information; and
route the one or more child requests to one or more external domains based on the declaration information.

15. An apparatus according to claim 14, wherein the apparatus is further caused to:
update the transaction based on one or more child responses corresponding to the one or more child requests;
determine one or more responses associated with the updated transaction; and
forward the one or more responses associated with the updated transaction to the resource manager.

16. An apparatus according to claim 9, wherein the apparatus is further caused to:
receive the request at one or more proxy servers, the one or more proxy servers hosting the one or more event packages.

17. A system comprising:
a resource manager configured to receive a request, the request specifying a feature and an action to be performed on the feature, and generate a modified request based on the request, the modified request including declaration information; and
a communication integration platform configured to generate a transaction based on a state of the feature and the modified request, and update a current state of the feature based on the transaction.

18. A system according to claim 17, wherein the communication integration platform is further configured to decompose the modified request into one or more child requests based on the declaration information, route the one or more child requests to one or more external domains based on the declaration information, update the transaction based on one or more child responses corresponding to the one or more child requests, determine one or more responses associated with the updated transaction, and forward the one or more responses associated with the updated transaction to the resource manager.

19. A system according to claim 18, wherein the request is received from a user agent associated with an application executed by a user device, and the external domain is associated with at least one of telephony services, calendar services, directory services, and conference services.

20. A system according to claim 17, wherein the resource manager is further configured to generate the modified request to include a behavior declaration, a structure declaration, or a combination thereof based on the feature, the action to be performed on the feature, or the combination thereof.
